(19) United States
(12) Patent Application Publication
(10) Pub. No.: US 2022/0164616 A1
(43) Pub. Date: May 26, 2022

(54) METHOD FOR PRODUCING A LABEL COMPRISING A HIDDEN SECURITY CODE AND METHOD FOR IMPLEMENTING SAID LABEL

(71) Applicant: NOVATEC, MONTAUBAN (FR)

(72) Inventors: Francis BOURRIERES, Montauban (FR); Franck BOURRIERES, MONTAUBAN (FR)

(21) Appl. No.: 17/438,125

(22) PCT Filed: Mar. 13, 2020
(86) PCT No.: PCT/EP2020/056980

§ 371 Date: Feb. 4, 2022

(30) Foreign Application Priority Data
Mar. 14, 2019 (FR) FR1902627

(51) Int. Cl. G06K 19/06; G06K 19/18

(52) U.S. Cl. CPC G06K 19/06056; G06K 19/18; G06K 19/06093

(57) ABSTRACT

An authentication system includes a label having at least three codes which are not known from a single database when the label is produced, but from at least two databases generated by independent processes such that it is not possible, without consulting the different databases, to know if a label is authentic, even when the three codes become accessible in the public domain. More particularly, an authentication system includes a label having at least three codes for identifying and validating the authenticity of said label, where the system includes:—at least two independent databases in which said at least three codes are entered, and each database includes, an unknown code from the other database, and a known code from the two databases, said known code being paired with one of said unknown codes.

### CROSS REFERENCE TO RELATED APPLICATIONS

This application is a National Stage of International Application No. PCT/EP2020/056980, having an International Filing Date of 13 Mar. 2020, which designated the United States of America, and which International Application was published under PCT Article 21(2) as WO Publication No. 2020/183017 A1, which claims priority from and the benefit of French Patent Application No. 1902627, filed on 14 Mar. 2019, the disclosures of which are incorporated herein by reference in their entireties.

### BACKGROUND

### 1. Technical Field

The present disclosure belongs to the field of labels including markings, at least one security code of which is hidden and the secure manufacturing and implementation method thereof.

The present disclosure relates to an authentication system including a label having three codes and two independent databases in which said codes are saved, each database including an unknown code from the other database and a known code from two databases.

In particular, the present disclosure proposes an authentication system architecture dividing the data necessary for the manufacture of an authentic label into two independent databases. This architecture will allow, on the one hand, preventing a fraud during the manufacture of the labels, on the other hand, the verification of the authenticity of a label can only be done by consulting two independent databases. It will then be possible to assign the management of databases to different actors and to integrate logistics solutions with multiple actors in the method for controlling a label.

In a non-restrictive manner, the term “label” will be used to designate a marking support.

The present disclosure also relates to a method for producing the label of said authentication system and a method for controlling such a label.

### 2. Brief Description Of Related Developments

The use of security codes hidden on labels is known.

Such security codes are made invisible so as not to be read until a step of controlling or validating the label in which the security code is made visible.

Such labels are often used in applications assigning a value indirectly to said hidden code. For example, the code can determine the access to secure data or services, or determine the winner of a game involving a significant economic gain. When the value assigned to this secret code is high, the interest in fraudulently acquiring said labels is also increased.

Several solutions exist today to prevent copying or reusing security or authentication label. These solutions only target fraud after the labels become accessible in the public domain and do not consider a possible fraud by the authorised label manufacturer.

There is therefore an interest in creating an authentication system allowing improving the security of label manufacturing, as well as allowing simplifying the compliance with security and confidentiality standards for the entity in charge of producing said labels. It is also desired an authentication system allowing the integration of logistics functions other than the simple validation of the authenticity of a product or the traceability of a product.

### SUMMARY

The present disclosure provides a solution to these difficulties by means of an authentication system including a label having at least three codes which are not known from a single database during the production of the label, but from at least two databases generated by independent processes such that it is not possible, without consulting the different databases, to know if a label is authentic even when the three codes become accessible in the public domain.

More particularly, the present disclosure proposes an authentication system including a label having at least three codes for identifying and validating the authenticity of said label, characterised in that the system includes:
at least two independent databases BD in which said at least three codes are entered,
   and in that each database BD includes:
an unknown code from the other database,
a known code from two databases,
said known code being paired with one of said unknown codes.

It is thus possible to divide the data necessary for the illegal reproduction of a label into two independent databases, that is to say databases built and managed individually. The access and the modification of each database will therefore include a specific secure access to said database. The authorisation to access one database does not imply an authorisation to access the second database.

This system is very advantageous because the protocol for confidentiality and authorised access to each database will be less restrictive than the protocol required when a single database contains all information necessary to consider a system fraud.

The present disclosure proposes, without limitation, to implement this system by means of a label in which the three codes correspond to:
a hidden secret code corresponding to a first code called unknown code present only on one of the databases;
a unique tracking code which is visible and corresponding to said code called known code from two databases;
a serial code which is visible and corresponding to a second code called unknown code and present only on one of the databases;

and the two databases correspond to:
a first database in which the serial code and the tracking code are paired
a second database in which the secret code is paired with the tracking code.

In a preferred embodiment of the present disclosure, the label includes:
a rear substrate including the hidden or masked secret code and the tracking code paired in said second database corresponding to a “rear substrate database” BDar,
a front substrate, superimposed on said rear substrate and determining a front face for reading the label, said front substrate including the serial code and being superimposed on the rear substrate so as to allow the readability of the tracking code,

and in which system, the serial code and the tracking code are paired in the first database corresponding to a database of entered labels BDen.

The present disclosure also relates to the method for making said authentication system including a label with two superimposed substrates:
a step A of making a rear label substrate including the steps:
   of printing on said rear substrate, a tracking code and a secret code;
   of optional deposition of a mask on the secret code;
   of pairing the tracking code and the secret code, in a database BDar of the rear substrates;
a step B, independent of step A, of making a front substrate, including printing a unique serial code,
a step C of forming the label, including the steps:
   of assembling the front substrate on the front face of the rear substrate, such that the secret code is covered by said front substrate and such that the tracking code remains visible from the front face of the label;
   of reading the serial code and the tracking code of the label;
a step D of entering the label in which entering step, the serial code of the label and the tracking code are paired in a database BDen of the entered labels; and in which method, each database BDar, BDen is constructed, modified and managed independently of the other database.

In this way, the secret code is not known to the manufacturer of the front substrate and to the operator making the assembly of the front substrate and the rear substrate that would not have access to the database of the rear substrates. The serial code of a label is also not known to the manufacturer of the rear substrate who would not have access to the label entering database.

In the manufacturing process of the label, only the entering of the label allows a posteriori control of the authenticity of the label by allowing the reconciliation of the two databases BDar and BDen by means of the intermediary of the tracking code. This entering can be performed during step C of assembling the label or during its first use in view of its verification.

The independence of steps A, B and C for their respective implementations is a security element in the method, which makes it more difficult for fraud on the labels obtained by the method.

As far as they are technically combinable, the authentication system and/or the method for making said system includes, where appropriate:

a preliminary step in which attributes of a family of labels, to which the label belongs, are defined, said attributes including dimensions of the front substrate and of the rear substrate and the locations of the different markings including the serial code, the tracking code and the secret code.
that at least two steps from step A of making a rear substrate, step B of making a front substrate and step C of forming the label are implemented at different times, and/or in different places and/or by different operators.
that during the assembly of the front substrate on the front face of the rear substrate in step C of forming the label, the tracking code of said rear substrate is not covered by the front substrate or is visible through a transparent window of said front substrate.
that the tracking code and the secret code of the rear substrate are taken from a list of tracking codes and secret codes from the database BDar of the rear substrates made earlier for a family of labels, among the tracking codes having not been previously assigned to a rear substrate, and in which database BDar, each tracking code is paired with a secret code.
that the serial code of the front substrate is taken from a list of serial codes from the BDav database of the front substrate made earlier for a family of labels, among the serial codes having not been previously assigned to a front substrate.
that the mask is made by means of an opaque scratchable ink or by means of an opaque adhesive film which can be peeled off.
that all or part of the markings of the front substrate are made on a rear face of the front substrate in a transparent area of the front substrate to be readable in window sticker from the front face of the front substrate.
that the serial code is incorporated into all or part of: an alphanumeric string, a bar code, a two-dimensional code, a contactless reading electronic chip.
that a url for connecting to a service for verifying the authenticity of the label is incorporated into a two-dimensional code and/or into a contactless reading electronic chip.
that the serial code is printed on the front substrate to be physically superimposed on the mask in the label and such that access to the secret code results in the destruction of the serial code marking.
that the tracking code is incorporated into a two-dimensional code and/or into a contactless reading electronic chip.

The present disclosure also relates to a method for implementing an authentication system, including:
a first step of accessing a software application by means of acquiring a serial code, said software application being configured to query the first database and verify said serial code and the tracking code paired in the database BDen, said database BDen being managed by a first actor; said first actor is for example a trusted third party responsible for attesting the freedom of use when this label has not yet been used or, on the contrary, its invalidation when it has been used;
a second step, performed following a positive verification during the first step, in which the software application queries a second database BDar by means of the tracking code to obtain the secret code paired with said tracking code, said second database being managed by a second actor;
a third step in which a label is authenticated when the secret code transmitted by the rear substrate database corresponds to the secret code read on the label, and
a fourth step in which the software application informs the first database BD1, BD2 of the use of the secret code

It should be noted that the third step can be validated either by the software application, or by a user of the label, or by the manager of a database without departing from the scope of the present disclosure.

In the fourth step, the software application can be configured to inform the BDen of either:
the use of the secret code or of the secret code and tracking code pair of the label;
a possible invalidation of said code(s); or
a number of attempts to use said code(s).

In a preferred embodiment, the first step includes the acquisition of the serial code by means of a portable terminal, and optionally of the tracking code, readable from a front face of said label; and

the second or third step include:
a removal of a front substrate from the label to free a front face of a rear substrate and an elimination of a mask covering the secret code so as to make it readable;
the acquisition of the secret code and verification by the software application that said secret code corresponds to the secret code paired with the tracking code in the database BDar.

This embodiment is suitable for applications in which the verification of the secret code represents the final objective of the authentication system, this secret code allowing verifying the authenticity of a product to which this label has been assigned. It is also possible to exploit this authentication system for the production of labels for a lottery game or any game with an economic stake, in which the system is reinforced against a potential fraud from manufacturers and game organisers.

In an alternative implementation of the method, the present disclosure proposes to use the labels of the system of the present disclosure to deploy logistics solutions with multiple actors, in particular to integrate an actor other than the managers of the databases. More particularly, the present disclosure proposes to configure the software application to simultaneously send, during the first step, the tracking code to a third actor, and during the third step, the result of the authentication of the label is also transmitted to said third actor.

In this embodiment, the third actor validates an action following the authentication of a label, and identification data of said act are entered in at least one of the two databases, associated with at least the one of the codes on the label. For example, the system label can become accessible in the public domain and be used as a stamp for the electronic sending of a document, this system allowing ensuring the traceability of the sending and the reception of said message.

A method is thus proposed in which the action validated by the third actor is an electronic sending of a document to a person holding a label of the system to which a stamp function is assigned, and in which a digest of said document is saved in one of the databases associated with at least one of the codes of the label.

In one embodiment, the authentication system includes a database BDst including a status code which indicates that the label, identified by the serial code recognised as paired, directly in the database BDen of the entered labels has been or not implemented during a first control, and the method for implementing the system includes the emission of a rejection message when said status code indicates that said label has been implemented in a previous control.

### BRIEF DESCRIPTION OF THE FIGURES

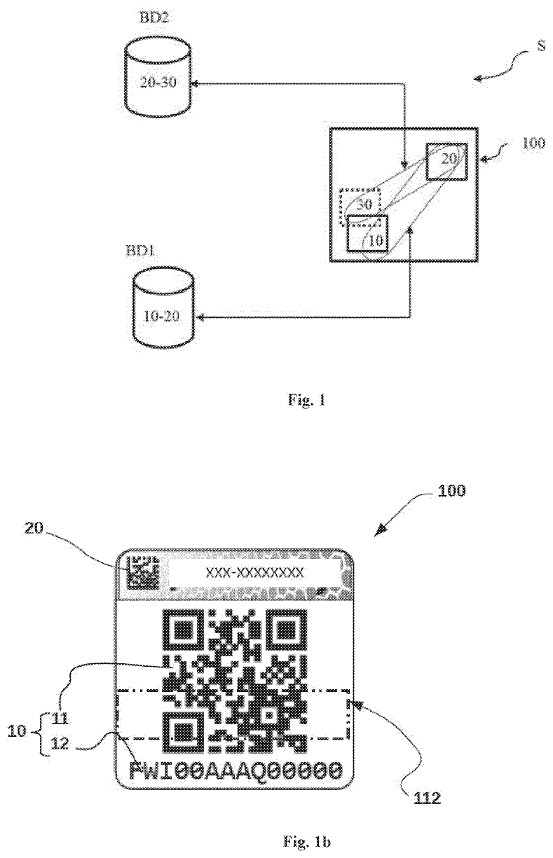

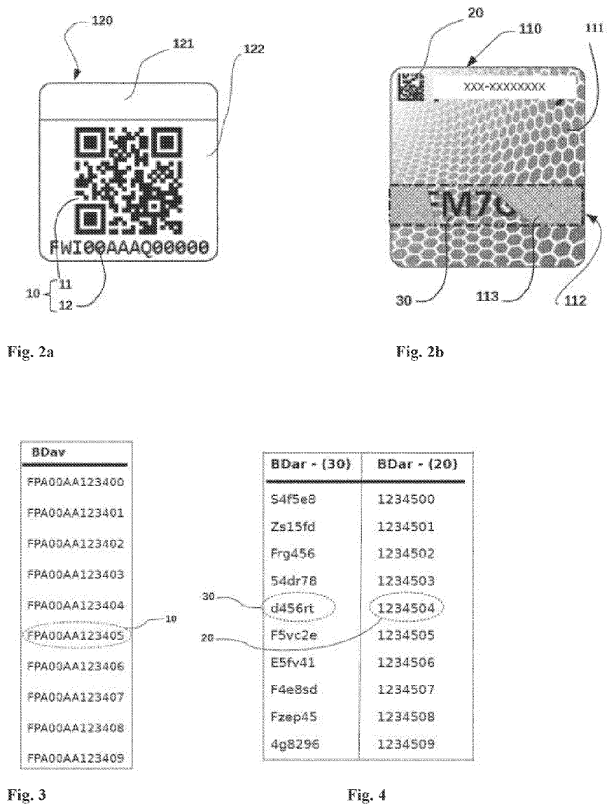

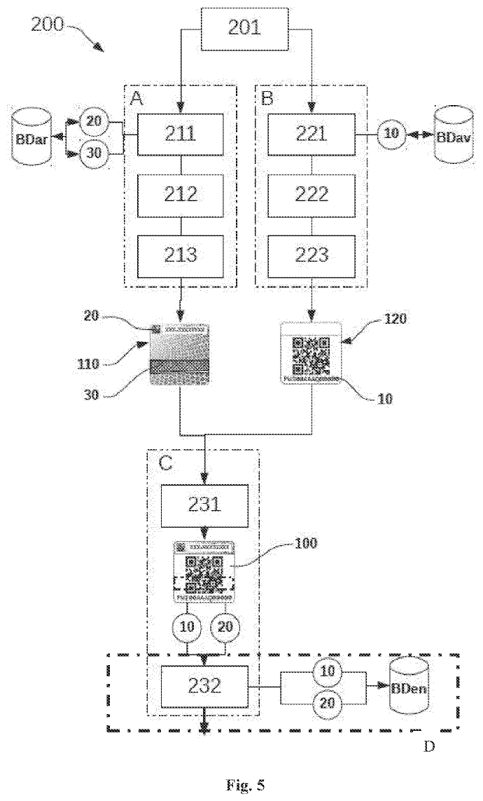

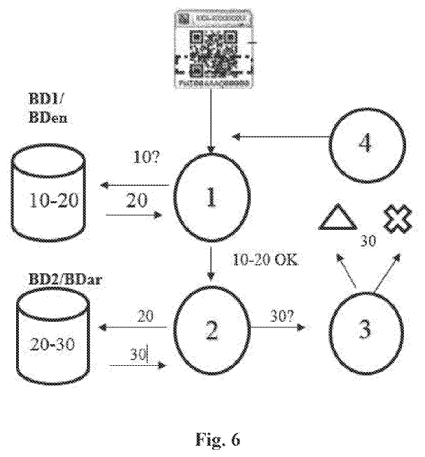

The authentication system of the present disclosure is described in detail in support of a non-limiting example of the structure of a label and its production and implementation methods with reference to the drawings which represent in a non-limiting manner by way of example:

[FIG. 1] A representation of the authentication system of the present disclosure.

[FIG. 1b] A label according to the system of the present disclosure in one aspect that it presents applied to a product before alteration;

[FIG. 2a] An exploded view of the label of FIG. 1 showing a front substrate

[FIG. 2b] An exploded view of the label of FIG. 1 showing a rear substrate, which is assembled superimposed on the front substrate of FIG. 2a in the label of FIG. 1;

[FIG. 3] A list of serial codes entered in the database BDav of the system of the present disclosure;

[FIG. 4] A list of “secret code-tracking code” pairs entered in the database BDar of the system of the present disclosure;

[FIG. 5] A schematic representation of a method of making an authentication system including a label such as the label in FIG. 1;

[FIG. 6] A schematic representation of a method for implementing the authentication system of the present disclosure.

In the figures, the represented patterns and codes, corresponding to markings affixed to the substrates of the label, are given only by way of example as a support for the description, these patterns and codes being able to take very different aspects in a group of labels and between different groups of labels. The term “marking” should be considered herein for the graphic representation of its content, regardless of the print support. These codes can be printed or else, present in the form of a contactless type electronic chip.

### DETAILED DESCRIPTION

The present disclosure proposes an authentication system S (FIG. 1) including a label 100 including at least three codes 10, 20, 30 for identifying and validating the authenticity of said label, characterised in that the system S includes:
at least two independent databases in which said at least three codes are entered,

and in that each database includes:
an unknown code 10, 30 from the other database,
a known code 20 from two databases,
said known code being paired with one of said unknown codes.

FIG. 1b illustrates an example of a label 100 as it is, or will be, applied on a product, such as equipment, packaging or document.

The label of FIG. 1b is the result of the superposition, in whole or in part, of at least one rear substrate 110 and one front substrate 120, as illustrated in FIGS. 2a and 2b.

In the remainder of the description, the terms “front” and “rear” must be understood in relation to an observer of the label who should read the label, the front of the label being located on the side of the observer, the back being located on the opposite side.

In the illustrated example, the label has a substantially square shape. This simple and conventional shape for a label is not, however, limiting and the label may have any shape as long as it is not incompatible with the essential features of the label of the present disclosure which will be detailed below.

The front 120 and rear 110 substrates are also illustrated with the shape and the dimensions of the label 100 although these shape and dimension conditions are not essential as will be understood from the following description.

The front substrate 120 is located, relative to the rear substrate 110, on the front side of the label 100 when said label is affixed to a product.

The front substrate 120 includes at least one transparent window 121, in the example illustrated in the form of a strip in the upper portion of said front substrate, which, when said front substrate is superimposed on the rear substrate 110 in the label 100, leaves visible a corresponding area 111 of said rear substrate covered by said front substrate.

The transparent window 121 results, for example, from the implementation of a material of the transparent substrate or of an area of the front substrate without material, for example an opening or a notch in the front substrate.

The front substrate 120 also includes at least one marking area 122 including at least one front marking corresponding to a serial code 10.

The marking area 122 is distinct from the transparent window 121.

The marking area 122 may be totally or partially transparent in whole or in part, provided that the portion of the rear substrate 110 which is visible through this marking area does not interfere with the reading of the marking(s) of the front substrate.

In one embodiment, the front substrate markings are made on a front face, therefore on the side of a reader of the label 100 affixed to a product, of the front substrate 120.

In another preferred embodiment, the front substrate 120 is transparent in an area of said front substrate where markings are made on a rear face of said front substrate. In this embodiment, where appropriate the rear face of the front substrate and the markings made on this face are covered, at the locations where it is necessary or desirable to improve the reading contrast of the markings, with an opacifying layer to mask the rear substrate 110 and improve the readability of the markings in the marking area 122. This embodiment allows protecting by means of the front substrate itself, the markings in the marking area 122 from various common mechanical or chemical attacks which could accidentally erase said markings.

In another embodiment, which can be combined with other embodiments, the serial code 10 is contained in a contactless queryable electronic chip, e.g. an RFID chip.

The serial code 10 is an indicator of a unique label number within a label family, which implies that only one label of said label family carries a given serial code.

The serial code 10 can be presented in the form of an alphanumeric code 11 and/or in the form of a graphic code 12 such as a bar code or a two-dimensional code, e.g. a QR code, as illustrated in the Figures.

The use of a two-dimensional code allows, in a known manner, associating additional information with the serial code, for example information on the address of the user of the product bearing the label, for example a URL address., which can be read by means of a conventional reader, for example a telephone-computer including an image sensor and including a software for interpreting the two-dimensional code.

The serial code 10 is generated in a conventional manner. It corresponds, for example, to a number of the label in a series. It corresponds, for example, to a serial number of the product on which the label is, or will be, affixed. The serial code 10 can be serialised, or random.

The rear substrate 110 includes at least two areas including a visible area 111 and a hidden area 112.

The visible area 111 is, in the label 100, opposite to the transparent window 121 of the front substrate 120 such that a marking on the rear substrate 110 in said visible area can be observed from the front face of the label.

The hidden area 112 is, in the label 100, located under the front substrate 120, for example under the marking area 122 of said front substrate. Said hidden area is thus protected by the front substrate 120.

The visible area 111 of the rear substrate 110 includes at least one tracking code 20, which tracking code is a unique identifier of the rear substrate 110, which implies that only one label of said label family carries a given tracking code. The tracking code 20 can be serialised or random.

The visible area 111 of the substrate 110 can advantageously integrate security elements to allow the authentication of the label. By way of example, the substrate can be a substrate called security substrate with fibres or bubbles, or else the printing can integrate security elements such as inks or a metallisation or security printing.

The tracking code 20 of the label 100 is therefore readable directly through the transparent window 121. Said tracking code can be readable by any means adapted for its representation. It may be intelligible in the form of an entered alphanumeric string. It can be read by ordinary technical means, for example in the form of a bar code or a two-dimensional matrix code visible in white light, as illustrated in the figures, or in ultraviolet or infrared spectra, outside the visible range.

It can also, alternatively or in combination with other forms, be contained in a contactless query electronic chip, e.g. an RFID component. In the latter case, the transparency of the front substrate 120 is a transparency to radio-electric waves which enables reading said electronic chip through said front substrate.

Where applicable, the tracking code is encrypted.

The hidden area 112 includes at least one secret code 30, which is optionally covered on a front face of the rear substrate 110 with a mask 113, for example a scratchable ink, which makes the secret code 30 invisible even if the front substrate 120 is transparent or when said front substrate is removed from the label 100. This mask is subsequently removed to allow the readability of the secret code. In another embodiment, the secret code is only hidden by the presence of the front substrate superimposed on said rear substrate, and said hidden code becomes readable when the front substrate is peeled off from the rear substrate.

The secret code 30 is a random code, for example an alphanumeric code, without correlation with the tracking code 20 nor with the serial code 10.

Thus the label 100 includes at least:
one optionally masked secret code 30 corresponding to one of said unknown codes
one unique tracking code 20 which is visible, readable by transparency in the transparent window 121 of the front substrate and corresponding to said code known by the two databases;
one unique serial code 10 which is visible; and corresponding to one of said unknown codes

And the two databases correspond to:
a first database in which the serial code and the tracking code are paired
a second database in which the secret code is paired with the tracking code

Advantageously, the front substrate 120 is attached to the front face of the rear substrate 110 by means of an adhesive which allows the peeling of said front substrate without damaging said rear substrate, but by sufficiently degrading said front substrate so that it is no longer possible to reattach it on the rear substrate, at least without this attempt at reconstruction being clearly visible.

In a particular embodiment, the serial code is printed on the front substrate 120 to be in the label which is physically superimposed on the mask 113. Thus, in order to access the secret code 30, the destruction of the front substrate 120 also leads to the destruction of the serial code 10.

The serial code 10, the tracking code 20 and the secret code 30 cannot be reconciled by any logical link, said codes having been generated independently.

Description of a Method for Making the Authentication System

Such a result is obtained by a method 200 for making a label 100 which includes the generation of the serial codes 10, the tracking codes 20 and the secret codes 30 of the labels of a family of labels and the construction of databases of controlling said codes.

In the description of the method for making a label, it will be considered that the different markings are printed on the substrates.

The term “printed” should be considered herein, in the broad sense, as any technique that can be implemented to create markings on a substrate, the techniques in question being numerous and varied without the choice of a particular technique being critical in the context of the present disclosure.

It will not be more detailed the type of materials implemented for the front and rear substrates, which can be of any kind, in particular polymers, compatible with the intended use of the labels and with the specific requirements of this method.

By way of example, the codes are printed with digital presses or inkjet printheads. The materials are for example papers or polymer films depending on the technical constraints of the product to be marked.

According to the production method 200, shown schematically in FIG. 5, the front substrate 120 and the rear substrate 110 of a label 100 are produced independently of each other. Preferably, for large series production, the substrates 110 and 120 are printed in two individual coils independent of the identical pitches then the two coils are then assembled by adhering the front coil 120 on the rear coil 110 so as to allow the tracking code 20 to appear for each label. The assembly forms a third coil carrying labels 100. The BDen of each label of the final assembled coil is then produced in series by subjecting this assembled coil to unwinding in front of a high speed capture system which will read and link each serial code 10 to each tracking code 20.

By independently, it should be understood that in order to make the front substrate and the rear substrate there is no requirement of unit of time, unit of place, nor unit of actor. Only the structure of the substrates is imposed by the need to accurately assemble them when producing the label by ensuring the readability of the codes to be used when using the label.

In a preliminary step 201, the structure of the labels of a family of labels to be printed is defined. In this preliminary step, the dimensions of the labels 100 and the front 120 and rear 110 substrates are defined as well as the locations of the different markings on said front and rear substrates, as well as the location and dimensions of the transparent window on the front substrate.

In a step A, the rear substrate 110 is made.

In an identification step 211 of step A, at least one unique tracking code 20 and at least one secret code 30 are defined for the rear substrate 110, and said at least one tracking code and at least one secret code are paired in a database BDar of the rear substrates, illustrated in FIG. 4.

In one form of implementation, the database BDar is previously generated with a list of tracking codes and secret codes to be used and each serial code and a secret code to which it is paired are assigned to a single rear substrate.

In a printing step 212 of step A, the markings, at least the tracking code 20 and the secret code 30, are printed on the front face of the rear substrate 110 in the shapes and at the locations defined in the preliminary step 201.

In a masking step 213 of step A, the secret code 10 is covered with the mask 113 to be non-visible unless said mask is removed.

In a step B, independent of step A, the front substrate 120 is made.

In a serialisation step 221 of step B, at least one unique serial code 10 is defined for the front substrate 120 and stored in a database BDav, illustrated in FIG. 3. In one form of implementation, the database BDav can be previously generated with a list of serial codes to be used and each serial code is assigned to a single front substrate when making the front substrates.

In a printing step 222 of step B, at least the serial code 10 is printed on the front substrate 120 in the shape(s) and at the locations defined during the preliminary step 201.

As already stated, step A of making the rear substrate and step B of making the front substrate can be executed independently of each other, in particular at different times and in different places.

In a step C, subsequent to steps A and B, the label is formed.

In an assembly step 231 of step C, the front substrate 120 is attached superimposed on the rear substrate 110 in the arrangement defined during the preliminary step 201.

It should be noted that for the production of batches of labels of the same family, it is in practice produced, on the one hand, a necessary number of rear substrates and, on the other hand, a necessary number of front substrates, and that during the assembly step 231, a front substrate is superimposed on a rear substrate without consideration of their serial codes and their respective tracking codes. As previously mentioned, a coil packaging is preferable.

According to one embodiment, not illustrated in the figures, in the entering step, the serial code 10 and the tracking code 20 read on the label are paired in the database BDen of the entered labels without the code secret 30 being known to said entering step.

This entering step is advantageously carried out by an entering device, not represented in the figures, which automatically reads the serial code and the tracking code of the label 100 in order to enter them paired in the database BDen.

The database BDen can be created during the entering step or result from an enrichment of the database BDav.

Step C, necessarily subsequent to steps A and B for producing the front and rear substrates, can be carried out independently, in particular in different places and by different operators.

After the end of step C, the label 100 is ready to be affixed to a product and implemented.

Advantageously, each database BDar, BDen is built, modified and managed independently of the other database. The access to and the modification of each database will therefore include a specific secure access for said database. The authorisation to access one database does not imply an authorisation to access the second database.

This system is very advantageous because the protocol for confidentiality and authorised access to each database will be less restrictive than the protocol required when a single database contains all information necessary to consider a system fraud.

Implementation of the Label

The system of the present disclosure is implemented 300 to control the labels and detect a marking of a product by a fraudulent label or the fraudulent use of the codes of a label.

By its principle, a label 100 includes at least one serial code readable without altering said label and at least one hidden secret code which only becomes readable by permanently altering the label, said serial code and said secret code being printed on different substrates of the same label and paired in a database.

As a result, a label 100 can only be recognised with certainty by knowing said at least one serial code and one secret code, which for the latter requires destroying the physical integrity of said label.

The different steps of this implementation are for example carried out by means of a portable terminal or telephone-computer which is remotely connected to a server, not represented in the figures, in charge of carrying out the different verifications by querying the databases to which said server has the necessary access capacities.

Advantageously, the present disclosure proposes to allocate the management of the two databases BDar, BDen to different actors, and to query said databases by means of a software application which can be accessed by means of a reading of the serial code 10, and optionally the tracking code 20 by a portable terminal during a first step of said method.

More particularly in a first step (FIG. 6), said software application is configured to query the first database BDen and verify whether said serial code and the tracking code are present and coupled, said database BDen being managed by a first actor who certifies their freedom of use or their invalidity.

During a second step, the software application queries the second database BDar by means of the tracking code (20) to obtain the secret code paired with said tracking code (20), said second database being managed by a second actor.

In a third step, a label is authenticated when the secret code transmitted by the rear substrate database corresponds to the secret code read on the label.

In a fourth step, the BDen informs the BDar of the use of the label and its possible invalidation or of a prosecution for N uses. Thus it should be noted that the label physical and software system allows a closed loop use.

The term “actor” means any natural or legal person responsible for managing the database or at least having an authorised access to information obtained from said databases. This actor is for example the holder of rights of a product to be authenticated, or of the labels having a commercial value in itself or allowing the access to a service, either a trusted third party of the holder of rights, or the supplier of the service associated with the label etc.

According to one embodiment of the authentication system specific to the label 100, the database BDen of the entered labels includes the serial code 10 and the tracking code 20 which are paired, the method includes a verification step by querying the database BDar of the rear substrates that the secret code 30 read on the label, after removal of the front substrate 120 and elimination of the mask 113 to make the latter readable on the label, effectively corresponds to the secret code paired in said database BDar to the tracking code of said label.

Thus, according to this implementation, actions are taken:

During the first step;
reading the serial code 10, and optionally the tracking code 20 of the label;
querying the database BDen of the entered labels to verify that said serial code and said tracking code are entered paired in said database BDen and free to use;

During the second or third step
removing the front substrate 120 from the front face of the rear substrate 110 and eliminating the mask 113 to make the secret code 30 readable;

During the third step
reading said secret code and querying the database BDar of the rear substrates to verify that said tracking code, and indirectly the serial code 10, and said secret code are paired in said database BDar, and emitting a rejection message if this is not the case.

The system can implement a verification system in a database BDst of a status code indicating whether the label 100 has been previously implemented during a control.

Such a status code corresponds for example to a binary indicator “used/not used” initialised to the value “not used” for each label identified by its serial code and/or its tracking code. When checking the status code of the label 100:
if the status code corresponds to “used”, emission of a rejection message;
if the status code corresponds to “not used”, emission of an acceptance message and change of said status code from “not used” to “used”.

Advantageously, the status codes are entered in the database BDen of the entered labels and the database BDst corresponds in this case to a subset of the database BDen.

Application

Such a label allows implementing a secret code in a secure manner without however using expensive technologies, or restrictive confidentiality protocols when producing labels and databases, which allows an extensive use of the labels, including included on low value products.

The difficulty in reproducing such a label can also be increased by implementing solutions of the non-reproducible marker type, for example including coloured fibres or bubbles trapped in a transparent material, and solutions for encrypting the codes. The present disclosure thus allows verifying the authenticity of a label affixed to a product, the right of a user to own a product or to access associated functions or else to ensure a traceability of a product.

Apart from the knowledge of label entering databases, only the simultaneous presence of these three codes on the label 100 links them and a careless user cannot, from a label, create a similar label with the certainty that the label corresponds to a real label, except for an identical label whose counterfeiting will be detected during the implementation of the label.

In another embodiment of the authentication system, the present disclosure proposes to deploy logistics solutions by means of the authentication system of the present disclosure, such as controlling the access to a function or service of a third actor not having a direct link with the production of the label and the databases. For example, the present disclosure proposes using the labels of the system as a stamp to access a secure and traceable transmission service of an electronic document, for example to certify the sending and receipt of an official document between an individual and a private or public entity.

In this embodiment, the stamp function is integrated into the label of the present disclosure by means of the tracking code or the serial code also including data allowing the software application to come into contact with the third actor, such as said public or private entity. The software application also informs the third actor of the label control result. The third actor will therefore send the document to the individual following a positive control of the label.

Advantageously, the present disclosure proposes to enter a document digest transmitted in at least one of the databases BD1, BD2, BDar, BDen, so as to keep a traceability of the transmitted document associated with the use of a label, by associating in the database a document digest with one of the codes 10, 20, 30 of the label. The term “digest” means the essential information to ensure the traceability of the sending and the reception of said document, and the essential information to identify the content of the document, i.e. a compressed version of said document, see the transmitted document.

The individual might also stick the label on a print of said transmitted document, said label demonstrating the authenticity of said document and subsequently allowing corroborating the act of transmission of said document as well as its integrity.

In another embodiment which is not illustrated, it will be possible for an individual to print their own label, this label including only the unique serial code and the unique tracking code. In this embodiment, the secret code does not become accessible in the public domain and can only be viewed and verified by means of the tracking code paired with said secret code in the database BDar. The third verification step is therefore only validated when the software application confirms the existence of the tracking code paired in the second database with a secret code, and confirms an available status of said pair of secret code and tracking code.

The example of a stamp is not limiting, but it shows how the label and the method which is the object of the present disclosure allows creating a physical and digital chain of trust in the tracking, delivery and integrity of information and information and objects. This stamp thus constitutes a printed physical component of digital security which has a universal use vocation in a digital universe to build connected solutions for traceability, authentication, integrity proof and evidence preservation. Thus, this present disclosure is particularly suitable for the marking of the objects for all applications using a blockchain.

What is claimed is:

1. An authentication system including a label having at least three codes for identifying and validating the authenticity of said label, characterised in that the system includes:
at least two independent databases BD in which said at least three codes are entered,
and in that each database BD includes:
an unknown code from the other database,
a known code from two databases,
said known code paired with one of said unknown codes.

2. The authentication system according to claim 1, wherein the at least three codes correspond to:
a hidden or masked secret code corresponding to a first code called unknown code and present only on one of the databases
a unique tracking code which is visible and corresponding to the code called known code of two databases;
a serial code which is visible and corresponding to a second code called unknown code and present only on one of the databases;
and the two databases correspond to:
a first database in which the serial code and the tracking code are paired
a second database in which the secret code is paired with the tracking code.

3. The authentication system according to claim 1, wherein said label includes two superimposed substrates:
a rear substrate including the secret code and the tracking code paired in said second database corresponding to a “rear substrate database” BDar,
a front substrate, superimposed on said rear substrate and determining a front face for reading the label, said front substrate including the serial code and being superimposed on the rear substrate so as to allow the readability of the tracking code and to hide the secret code,
and in which system, the serial code and the tracking code are paired in the first database corresponding to a database of entered labels BDen.

4. A method for making an authentication system according to claim 1, including:
a step A of making a rear label substrate including the steps:
of printing on said rear substrate, a tracking code and a secret code;
of optional deposition of a mask on the secret code;
of pairing the tracking code and the secret code, in a database BDar of the rear substrates;
a step B, independent of step A, of making a front substrate, including printing a unique serial code,
a step C of forming the label, including the steps:
of assembling the front substrate on the front face of the rear substrate, such that the secret code is covered by said front substrate and such that the tracking code remains visible from the front face of the label;
of reading the serial code and the tracking code of the label;
a step D of entering the label in which entering step, the serial code of the label and the tracking code are paired in a database BDen of the entered labels;
and in which method, each database BDar, BDen is constructed, modified and managed independently of the other database.

5. The method according to claim 4, further including a preliminary step in which attributes of a family of labels, to which the label belongs, are defined, said attributes including dimensions of the front substrate and of the rear substrate and the locations of the different markings including the serial code, the tracking code (and the secret code.

6. The method according to claim 4, wherein at least two steps from step A of making a rear substrate, step B of making a front substrate and step C of forming the label are implemented at different times, and/or in different places and/or by different operators.

7. The method according to claim 4, wherein during the assembly of the front substrate on the front face of the rear substrate in step C of forming the label the tracking code of said rear substrate is not covered by said front substrate or is visible through a transparent window of said front substrate and wherein:
the serial code is printed on the front substrate to be physically superimposed on the secret code in the label and such that the access to said secret code causes the destruction of the marking of said serial code.

8. The method according to claim 4, wherein all or part of the markings of the front substrate is made on a rear face of said front substrate in a transparent area of said front substrate to be readable in window sticker from the front face of said front substrate.

9. The method according to claim 4, wherein the serial code is incorporated into all or part of an alphanumeric character string, a bar code, a two-dimensional code, a contactless reading electronic chip.

10. The method according to claim 4, wherein the serial code and the tracking code are incorporated into a two-dimensional code and/or a contactless reading electronic chip, said tracking code also including a url for connecting to a service for verifying the authenticity of the label.

11. A method for implementing an authentication system according to claim 1, including:
a first step of accessing a software application by means of acquiring a serial code, said software application being configured to query a first database and verify said serial code and a tracking code paired in the database and their availability for use, said first database being managed by a first actor;
a second step, performed following a positive verification during the first step, in which the software application queries a second database by means of the tracking code to obtain a secret code paired with said tracking code, said second database being managed by a second actor,
a third step in which a label is authenticated when the secret code transmitted by the rear substrate database BDar corresponds to the secret code read on the label;
a fourth step in which the software application informs the first database of the use of the secret code.

12. The method for implementing an authentication system according to claim 12, wherein:
the first step includes the acquisition of the serial code by means of a portable terminal, and optionally of the tracking code, readable from a front face of said label; and
the second or third step includes:
a removal of a front substrate from the label to free a front face of a rear substrate and, where appropriate, an elimination of an optional mask covering the secret code so as to make it readable;
acquisition of the secret code and verification by the software application that said secret code corresponds to the secret code paired with the tracking code in the database BDar.

13. The method for implementing an authentication system according to claim 11, wherein during the first step the software application is configured to simultaneously send, the tracking code to a third actor, and during the third step:
the software application is configured to transmit the result of the authentication of the label to said third actor or;
the software application is configured to transmit the secret code of the second rear substrate database and the secret code read on the label so that said third actor validates the authentication of said label.

14. The method for implementing an authentication system according to claim 13, wherein the third actor validates an action upon authentication of a label, and identification data of said act are entered in at least one of the two databases associated with at least one of the codes of the label.

15. The method for implementing an authentication system according to claim 13, wherein the action validated by the third actor is an electronic sending of a document to a person holding a label of the system, and a document digest is saved in one of the databases associated with at least one of the codes of the label.

16. The method according to claim 11, wherein a database BDst includes a status code indicating that the label, identified by the serial code recognised as paired, directly in the database BDen of the entered labels was or was not implemented during a first control, and further including a step of verifying the status code of the label in the database BDst and wherein a rejection message is emitted when said status code indicates that said label has been implemented in a prior control.
